(19) United States
(12) Patent Application Publication
(10) Pub. No.: US 2009/0161267 A1
(43) Pub. Date: Jun. 25, 2009

(54) FERROMAGNETIC TUNNEL JUNCTION DEVICE, MAGNETIC HEAD, AND MAGNETIC STORAGE DEVICE

(75) Inventors: Kenichi KAWAI, Kawasaki (JP); Yasushi Nishioka, Kawasaki (JP); Yusuke Hamada, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/339,852

(22) Filed: Dec. 19, 2008

(30) Foreign Application Priority Data
Dec. 20, 2007 (JP) 2007-328143

(51) Int. Cl. G11B 5/33

(52) U.S. Cl. 360/324.2; G9B/5.104

(57) ABSTRACT

According to an aspect of an embodiment, a ferromagnetic tunnel junction device includes: a first pinned magnetic member including a ferromagnetic material having a boron atom; a second pinned magnetic member including a ferromagnetic material on the first pinned magnetic member, the content of the boron atom in the second pinned member being smaller than that in the first pinned member; and a first free magnetic member superposed with respect to the second pinned layer, including a ferromagnetic material. The ferromagnetic tunnel junction device further includes: an insulating layer between the second pinned magnetic layer and the first free magnetic layer; and a second free magnetic member including a ferromagnetic material having a boron atom on the first free magnetic member, the content of the boron atom in the second free member being smaller than that in the first free member.

### CROSS REFERENCE TO RELATED APPLICATIONS

This application is based upon and claims the benefit of priority from the prior Japanese Patent Application No. 2007-328143 filed on Dec. 20, 2007, the entire content of which is incorporated herein by reference.

### BACKGROUND

1. Technical Field

This art relates to a ferromagnetic tunnel junction, which is a magnetoresistive element having an electrical resistance varying with a magnetic field.

2. Description of the Related Art

Ferromagnetic tunnel junctions have a structure of ferromagnetic metal layer/insulating layer/ferromagnetic metal layer, and the insulating layer has an energy barrier through which electrons can pass by tunnel effect. A slash “/”, as used herein, indicates that materials or layers on both sides of the slash are layered. The tunneling probability (tunneling resistance) is known to depend on the magnetization state of the ferromagnetic metal layers on both sides. The tunneling resistance can therefore be controlled by changing the magnetization state of the ferromagnetic metal layers using a magnetic field. In general, ferromagnetic tunnel junctions have a structure of pinned magnetic layer (i.e. fixed magnetic layer)/insulating layer/free magnetic layer. An external magnetic field negligibly affects the pinned magnetic layer, but can easily reverse the magnetization direction of the free magnetic layer.

The tunnel magnetoresistance (TMR) effect of ferromagnetic tunnel junctions is greater than the anisotropic magnetoresistance (AMR) effect or the giant magnetoresistance (GMR) effect. Thus, magnetic heads including a ferromagnetic tunnel junction are expected to be effective in high-resolution magnetic read/write. For example, one proposed ferromagnetic tunnel junction Fe (001)/MgO (001)/Fe (001) includes a magnesium oxide (MgO) insulating layer and single-crystal iron (Fe) ferromagnetic layers. This ferromagnetic tunnel junction is reported to have a rate of magnetoresistance change (MR ratio) of at least 200% at room temperature. Because MgO ferromagnetic tunnel junctions can produce particularly large output, they are promising materials for magnetic heads. In ferromagnetic tunnel junctions including a MgO insulating layer, CoFe or CoFeB free magnetic layers are generally used. In a constant external magnetic field, CoFeB exhibits a greater magnetoresistance change than CoFe (see, for example, Japanese Laid-open Patent Publication No. 2006-319259).

However, the presence of boron on the insulating layer sides of the pinned magnetic layer and the free magnetic layer reduces the breakdown voltage of a ferromagnetic tunnel junction and causes low MR ratios.

### SUMMARY

According to an aspect of an embodiment, a ferromagnetic tunnel junction device includes: a first pinned magnetic member including a ferromagnetic material having a boron atom, the magnetization direction of the first pinned magnetic member being capable of being pinned; a second pinned magnetic member including a ferromagnetic material on the first pinned magnetic member, the magnetization direction of the second pinned magnetic member being capable of being pinned, the content of the boron atom in the second pinned member being smaller than that in the first pinned member; a first free magnetic member superposed with respect to the second pinned layer, including a ferromagnetic material, the magnetization direction of the first free magnetic member being variable; an insulating layer between the second pinned magnetic layer and the first free magnetic layer, the insulating layer being capable of conducting tunneling current therethrough; and a second free magnetic member including a ferromagnetic material having a boron atom on the first free magnetic member, the magnetization direction of the second free magnetic member being variable, the content of the boron atom in the second free member being smaller than that in the first free member.

### BRIEF DESCRIPTION OF THE DRAWINGS

FIG. 1 is a cross-sectional view of a ferromagnetic tunnel junction device according to a first embodiment;

FIG. 2 is a cross-sectional view illustrating that a head slider provided with a magnetic head including the ferromagnetic tunnel junction device according to the first embodiment planes over a magnetic recording medium;

FIG. 3 is a schematic view of a principal part of the head slider illustrated in FIG. 2;

FIG. 4 is a schematic view of a principal part of a magnetic storage device provided with a magnetic head including the ferromagnetic tunnel junction device according to the first embodiment;

FIG. 5A is a cross-sectional view of a magnetic random access memory (MRAM) including the ferromagnetic tunnel junction device according to the first embodiment;

FIG. 5B is an equivalent circuit diagram of the magnetic random access memory;

FIG. 6 is a cross-sectional view of a ferromagnetic tunnel junction device according to an embodiment;

FIG. 7 is a cross-sectional view illustrating a method for manufacturing a ferromagnetic tunnel junction device for use in the measurement of breakdown voltage;

FIG. 8 is a cross-sectional view of a ferromagnetic tunnel junction device for use in the measurement of breakdown voltage;

FIG. 9 is a graph illustrating the MR ratio as a function of the thickness of a second diffusion-blocking layer in ferromagnetic tunnel junction devices according to Examples 1 to 3 and Comparative Example 1;

FIG. 10 is a graph illustrating the MR ratio as a function of the thickness of a second diffusion-blocking layer in ferromagnetic tunnel junction devices according to Examples 5 to 8 and Comparative Example 1;

FIG. 11 is a graph illustrating the MR ratio as a function of the tunneling resistance RA in ferromagnetic tunnel junction devices according to Example 4 and Comparative Example 1;

FIG. 12 is a graph illustrating the ratio of the MR ratio in Example 4 to the MR ratio in Comparative Example 1 as a function of the tunneling resistance RA;

FIG. 13 is a graph illustrating the MR ratio as a function of the tunneling resistance RA in ferromagnetic tunnel junctions according to Example 8 and Comparative Example 1; and

FIG. 14 is a graph illustrating the ratio of the MR ratio in Example 8 to the MR ratio in Comparative Example 1 as a function of the tunneling resistance RA.

### DESCRIPTION OF THE PREFERRED EMBODIMENTS

A ferromagnetic tunnel junction device generally has a structure of pinned magnetic member (i.e. fixed magnetic member)/insulating layer/free magnetic member. A slash “/”, as used herein, indicates that materials or layers on both sides of the slash are layered. The pinned magnetic member is disposed between an antiferromagnetic layer and the insulating layer. The magnetization state of the pinned magnetic member is insignificantly changed by an external magnetic field. The insulating layer has an energy barrier through which electrons can pass by tunnel effect. The free magnetic member is in contact with the insulating layer. The magnetization direction of the free magnetic member can be easily altered by a magnetic field. The magnetic field is strong enough to alter the magnetization direction of the free magnetic member, and has a strength of several thousand amperes per meter.

The tunneling probability (tunneling resistance) is known to depend on the magnetization state of the magnetic members on both sides of the insulating layer. The tunneling resistance can therefore be controlled using a magnetic field. The tunneling resistance R is given by the following equation:

R=Rs+0.5ΔR(1−cos θ) (1)

wherein θ denotes a relative magnetization angle. The tunneling resistance is lowest (R=Rs) at θ=0 (i.e., the magnetization directions of the magnetic members are identical) and highest (R=Rs+ΔR) at θ=180° (i.e., the magnetization directions of the magnetic members are opposite).

This difference results from polarization of electrons in a ferromagnetic substance. In general, electrons assume two possible spin states: up (spin-up electron) and down (spin-down electron). Nonmagnetic metals contain spin-up electrons and spin-down electrons in equal numbers, and are therefore nonmagnetic on the whole. On the other hand, ferromagnetic substances contain spin-up electrons and spin-down electrons in different numbers, and therefore exhibit upward or downward magnetization on the whole.

In the tunneling of electrons, the electrons maintain their spin states.

An electron passes through an energy barrier into an unoccupied destination orbital. However, in the absence of unoccupied destination orbital, electrons cannot pass through the energy barrier.

The rate of change in tunneling resistance is a product of the polarizability of an electron source and the polarizability of a destination orbital, as given by the following equation (2):

ΔR/Rs=2×P1×P2/(1−P1×P2) (2)

wherein Rs denotes a tunneling resistance when the magnetization directions of the magnetic members on both sides of the insulating layer are identical; ΔR denotes a difference between a tunneling resistance obtained when the magnetization directions of the magnetic members are identical and a tunneling resistance obtained when the magnetization directions of the magnetic members are opposite, and depends on the material of the magnetic members; ΔR/Rs is the rate of magnetoresistance change (the rate of tunneling resistance change, MR ratio); and P1 and P2 denote the polarizabilities of an electron source and a destination orbital, respectively. The polarizability P is given by the following formula (3):

P=2(Nup−Ndown)/(Nup+Ndown) (3)

wherein Nup and Ndown denote the numbers of spin-up electrons and spin-down electrons, respectively. The polarizability P depends on the type of ferromagnetic metal. For example, the polarizabilities of NiFe, Co, and CoFe are 0.3, 0.34, and 0.46, respectively. Theoretically, about 20%, 26%, and 54% magnetoresistance change can be expected in NiFe, Co, and CoFe, respectively.

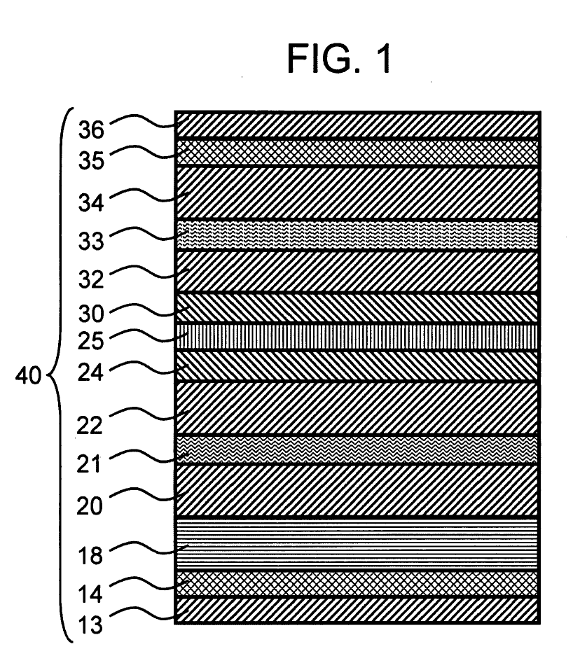

FIG. 1 is a cross-sectional view of a ferromagnetic tunnel junction device 40 according to a first embodiment.

The ferromagnetic tunnel junction device 40 according to the present embodiment is composed of a substrate (not shown), a first underlying layer 13, a second underlying layer 14, a pinning layer 18, a first pinned magnetic layer 20, a nonmagnetic coupling layer 21, a second pinned magnetic layer 22, a first diffusion-blocking layer 24, an insulating layer (barrier layer) 25, a second diffusion-blocking layer 30, a first free magnetic layer 32, a third diffusion-blocking layer 33, a second free magnetic layer 34, a first cap layer 35, and a second cap layer 36 in this order.

The first pinned magnetic layer 20, the nonmagnetic coupling layer 21, the second pinned magnetic layer 22, and the first diffusion-blocking layer 24 constitute the pinned magnetic member. The insulating layer 25 corresponds to the insulating layer. The second diffusion-blocking layer 30, the first free magnetic layer 32, the third diffusion-blocking layer 33, and the second free magnetic layer 34 constitute the free magnetic member.

The first underlying layer 13 may be formed of Ta and have a thickness of about 3 nm. The first underlying layer 13 may be formed of Cu or Au, or may be a laminate of a Cu layer and a Au layer. The second underlying layer 14 may be formed of Ru and have a thickness of about 2 nm.

The pinning layer 18 may be formed of IrMn and have a thickness of about 7 nm. The pinning layer 18 may also be formed of another antiferromagnetic material, for example, an alloy of Mn and at least one element selected from the group consisting of Pt, Pd, Ni, Ir, and Rh. The thickness of the pinning layer 18 ranges preferably from 5 nm to 30 nm and more preferably from 10 nm to 20 nm. The pinning layer 18 is ordered by heat treatment in a magnetic field after film formation, thus exhibiting antiferromagnetism.

The first pinned magnetic layer 20 may be formed of 65% by atomic weight Co and 35% by atomic weight Fe (Co65Fe35) and have a thickness of 2 nm. The numeral on the right side of an element symbol herein refers to the atomic weight ratio of the element. For example, a compound Co65Fe35 is composed of 65% by atomic weight Co and 35% by atomic weight Fe. The magnetization direction of the first pinned magnetic layer 20 is fixed to a predetermined direction by exchange interaction between the pinning layer 18 and the first pinned magnetic layer 20. The magnetization direction of the first pinned magnetic layer 20 is unchanged when the strength of an external magnetic field is lower than the strength of the exchange interaction. The first pinned magnetic layer 20 may also be formed of a ferromagnetic material containing one of Co, Ni, and Fe.

The nonmagnetic coupling layer 21 may be formed of Ru and have a thickness of 0.8 nm. The thickness of the nonmagnetic coupling layer 21 is determined such that antiferromagnetic exchange coupling occurs between the first pinned magnetic layer 20 and the second pinned magnetic layer 22. The thickness of the nonmagnetic coupling layer 21 ranges from 0.4 to 1.5 nm and preferably from 0.4 to 0.9 nm. The nonmagnetic coupling layer 21 may also be formed of another nonmagnetic material, such as Rh, Ir, a Ru alloy, a Rh alloy, and an Ir alloy. Examples of the Ru alloy include alloys of Ru and at least one element selected from the group consisting of Co, Cr, Fe, Ni, and Mn.

The second pinned magnetic layer 22 may be formed of Co40Fe40B20 and have a thickness of 2 nm. Antiferromagnetic exchange coupling between the first pinned magnetic layer 20 and the second pinned magnetic layer 22 occurs via the nonmagnetic coupling layer 21. As in the first pinned magnetic layer 20, the second pinned magnetic layer 22 may also be formed of a ferromagnetic material containing one of Co, Ni, and Fe.

Preferably, the second pinned magnetic layer 22 is amorphous. An amorphous pinned magnetic layer has negligible adverse effects on the crystallinity of the insulating layer 25, resulting in a high rate of magnetoresistance change of the tunnel junction device. Preferably, the boron content in the second pinned magnetic layer 22 is at least 10 atomic % so that the second pinned magnetic layer 22 is amorphous. However, excessive boron atoms may act as impurities and reduce the polarizability, resulting in a reduction in MR ratio. Thus, the boron content in the second pinned magnetic layer 22 is preferably 25 atomic % or less.

The crystallinity of a layer can be determined in the following way. When a distinct crystal lattice image is observed in a transmission electron microscope (TEM) image of a cross section of the layer, the layer is formed of a crystalline material. In contrast, when a distinct crystal lattice image is not observed, the layer is amorphous. Alternatively, when no diffraction line inherent in a crystalline material is observed in a diffraction pattern obtained by an X-ray diffraction (XRD) analysis, for example, an X-ray diffractometer (θ−2θ) analysis, the layer is amorphous. The term “amorphous”, as used herein, includes microcrystalline. A tunnel junction device including a microcrystalline second pinned magnetic layer has a higher MR ratio than a tunnel junction device including a crystalline second pinned magnetic layer. In general, amorphous and microcrystalline are difficult to differentiate clearly. The determination of crystallinity described above can also be applied to other layers.

The magnetization direction of the first pinned magnetic layer 20 is opposite to the magnetization direction of the second pinned magnetic layer 22. This results in a low overall strength of leakage magnetic field from the first and second pinned magnetic layers 20 and 22. Thus, the leakage magnetic field does not significantly alter the magnetization directions of the first and second free magnetic layers 32 and 34. The magnetization of the first and second free magnetic layers 32 and 34 properly responds to the leakage magnetic field from a magnetic recording medium. This improves the accuracy in detecting the magnetization retained in the magnetic recording medium. The first pinned magnetic layer 20, the nonmagnetic coupling layer 21, and the second pinned magnetic layer 22 constitute a “first pinned magnetic member” of a ferromagnetic tunnel junction device according to the present invention.

The first diffusion-blocking layer 24 may be formed of Co50Fe50 and have a thickness of 0.5 nm. The magnetization direction of the first diffusion-blocking layer 24 is the same as the magnetization direction of the second pinned magnetic layer 22 owing to the exchange interaction between the first diffusion-blocking layer 24 and the second pinned magnetic layer 22. The first diffusion-blocking layer 24 prevents boron atoms contained in the second pinned magnetic layer 22 and the lower layers from diffusing into the insulating layer 25. Preferably, the first diffusion-blocking layer 24 contains 50 to 90 atomic % Co in terms of spin polarizability. The first diffusion-blocking layer will be described in detail later.

The first diffusion-blocking layer 24 corresponds to a “second pinned magnetic member” of a ferromagnetic tunnel junction device according to the present invention.

The insulating layer 25 may be formed of MgO and have a thickness of 1.0 nm. Preferably, the insulating layer 25 is formed of crystalline MgO. More preferably, a MgO (001) plane is oriented substantially parallel to the substrate face. Preferably, the insulating layer 25 has a thickness in the range of 0.7 to 2.0 nm in terms of film properties. The insulating layer 25 may also be formed of AlOₓ, TiOₓ, ZrOₓ, AlN, TiN, or ZrN. When the insulating layer 25 is formed of a material other than MgO, the insulating layer 25 has a thickness preferably in the range of 0.5 to 2.0 nm and more preferably in the range of 0.7 to 1.2 nm.

The second diffusion-blocking layer 30 may be formed of Co50Fe50 and have a thickness of 0.5 nm. The magnetization direction of the second diffusion-blocking layer 30 is the same as the magnetization direction of the first free magnetic layer 32 owing to the exchange interaction between the second diffusion-blocking layer 30 and the first free magnetic layer 32. The second diffusion-blocking layer 30 prevents boron atoms contained in the first free magnetic layer 32 and the upper layers from diffusing into the insulating layer 25. Preferably, the second diffusion-blocking layer 30 contains 50 to 90 atomic % Co. A second diffusion-blocking layer containing more than 90 atomic % Co may have a low spin polarizability and a low MR ratio. The Co content less than 50 atomic % may result in large magnetostriction. Thus, use of the resulting tunnel junction device as a read element in a magnetic head may cause noise. The second diffusion-blocking layer will be described in detail later.

The second diffusion-blocking layer 30 corresponds to a “first free magnetic member” of a ferromagnetic tunnel junction device according to the present invention.

The first free magnetic layer 32 may be formed of a ferromagnetic material Co60Fe20B20 and have a thickness of about 1.5 nm. Preferably, the first free magnetic layer 32 is amorphous. An amorphous free magnetic layer has negligible adverse effects on the crystallinity of the insulating layer 25, resulting in a high rate of magnetoresistance change of the tunnel junction device. Preferably, the boron content in the first free magnetic layer 32 is at least 10 atomic % so that the first free magnetic layer 32 is amorphous. However, excessive boron atoms may act as impurities and reduce the polarizability, resulting in a reduction in MR ratio. Thus, the boron content in the first free magnetic layer 32 is preferably 25 atomic % or less. The first free magnetic layer 32 may also be formed of a soft magnetic material containing at least one element selected from the group consisting of C, Al, Si, and Zr.

Preferably, the composition of CoFe in the first free magnetic layer 32 is determined such that the crystal structure is resistant to deformation caused by an external magnetic field, that is, the crystal structure has low magnetostriction. Large magnetostriction may obstruct the movement of magnetization, thus impairing the soft-magnetic characteristics of the first free magnetic layer 32. Preferably, the ratio of cobalt to iron is at least 75 atomic %. However, even when the first free magnetic layer 32 contains iron and cobalt substantially in the same amount, the soft-magnetic characteristics of the first free magnetic layer 32 can be controlled by increasing the thickness of the second free magnetic layer 34. Thus, the CoFe composition in the first free magnetic layer 32 is not limited to the values described above.

The third diffusion-blocking layer 33 may be formed of Ta and have a thickness of 0.25 nm. The third diffusion-blocking layer 33 prevents boron atoms and other elements contained in the first free magnetic layer 32 from diffusing into the second free magnetic layer 34 during heat treatments in manufacturing processes. The heat treatments include a heat treatment for ordering the pinning layer 18 and a heat treatment for improving the film properties of the insulating layer 25. The third diffusion-blocking layer 33 can also prevent the diffusion of Co contained in the first free magnetic layer 32 and Ni contained in the second free magnetic layer 34. The third diffusion-blocking layer 33 also allows ferromagnetic exchange coupling between the first free magnetic layer 32 and the second free magnetic layer 34 to occur, thus altering the magnetization of the first free magnetic layer 32 and the second free magnetic layer 34 in the same direction. Preferably, the third diffusion-blocking layer 33 has a thickness in the range of 0.1 to 0.5 nm. When the third diffusion-blocking layer 33 has a thickness of less than 0.1 nm, boron atoms in the first free magnetic layer 32 may diffuse into the second free magnetic layer 34. When the third diffusion-blocking layer 33 has a thickness outside the range described above, it is difficult to alter the magnetization of the first free magnetic layer 32 and the second free magnetic layer 34 in the same direction. The third diffusion-blocking layer 33 may also be formed of at least one element selected from the group consisting of Ti, Ru, and Hf.

The second free magnetic layer 34 may be formed of Ni90Fe10 and have a thickness of 3 nm. The second free magnetic layer 34 may also be formed of CoNiFe or a soft magnetic material containing at least one element selected from the group consisting of B, C, Al, Si, and Zr. The second free magnetic layer 34 is formed of a soft magnetic material having a smaller coercive force than the soft magnetic material of the first free magnetic layer 32. Ferromagnetic exchange coupling between the first free magnetic layer 32 and the second free magnetic layer 34 can improve the sensitivity to an external magnetic field (responsivity of the magnetization directions of the free magnetic layers). In general, a ferromagnetic film having a smaller coercive force responds more readily to a change in the direction of an external magnetic field. The magnetization direction of the second free magnetic layer 34, which has a smaller coercive force than the first free magnetic layer 32, is altered more quickly by an external magnetic field than the magnetization direction of the first free magnetic layer 32. Owing to the ferromagnetic exchange coupling, the change in the magnetization direction of the second free magnetic layer 34 is followed by a change in the magnetization direction of the first free magnetic layer 32. Thus, the first free magnetic layer 32 becomes more responsive to an external magnetic field. Furthermore, owing to the ferromagnetic exchange coupling between the first free magnetic layer 32 and the second diffusion-blocking layer 30, the change in the magnetization direction of the first free magnetic layer 32 is followed by a change in the magnetization direction of the second diffusion-blocking layer 30. Because the magnetization direction of the second diffusion-blocking layer 30 correlates with the rate of magnetoresistance change, the second free magnetic layer 34 can improve the response of the ferromagnetic tunnel junction device to an external magnetic field.

The first free magnetic layer 32, the third diffusion-blocking layer 33, and the second free magnetic layer 34 constitute a “second free magnetic member” of a ferromagnetic tunnel junction device according to the present invention.

The first cap layer 35 and the second cap layer 36 prevent the oxidation of underlying layers during heat treatments and during the operation of the tunnel junction device. The first cap layer 35 may be formed of Ta and have a thickness of 5 nm. The second cap layer 36 may be formed of Ru and have a thickness of 10 nm. The first cap layer 35 may also be formed of Ru, and the second cap layer 36 may also be formed of Ta. The cap layers may also be formed of a nonmagnetic metal, such as Au, Ta, Al, W, or Ru, or may be a laminate of sublayers each formed of the nonmagnetic metal. Preferably, the total thickness of the cap layers ranges from 5 to 30 nm.

A ferromagnetic tunnel junction device according to the present embodiment includes the boron-free first diffusion-blocking layer 24 on the boron-containing second pinned magnetic layer 22 and the boron-free second diffusion-blocking layer 30 under the boron-containing first free magnetic layer 32.

The first diffusion-blocking layer 24 adsorbs boron atoms diffusing from underlying layers, and the second diffusion-blocking layer 30 adsorbs boron atoms diffusing from overlying layers. Thus, the diffusion-blocking layers prevent boron atoms from diffusing into the insulating layer 25. This diffusion prevention allows the insulating layer 25 to maintain an orientation producing a tunnel effect (for example, a (001) orientation in MgO), thus increasing the breakdown voltage of the tunnel junction device. Examples of a ferromagnetic material that has the diffusion preventing effect and can form exchange coupling with the second pinned magnetic layer 22 and the first free magnetic layer 32 include CoFe and NiFe. Preferably, the first diffusion-blocking layer 24 and the second diffusion-blocking layer 30 have a sufficient thickness to prevent the diffusion of boron atoms. The thickness is preferably at least 0.2 nm and more preferably at least 0.3 nm.

A ferromagnetic tunnel junction device according to the present embodiment also has an improved MR ratio. While the mechanism of improving the MR ratio is not clear, it is assumed as follows.

A ferromagnetic tunnel junction device that includes a crystalline ferromagnetic layer adjacent to an insulating layer is known to have a low MR ratio. For example, in a tunnel junction device that includes a (001)-oriented MgO thin film as an insulating layer between CoFe ferromagnetic layers, the orientation of MgO may vary with the crystal structure of CoFe in a heat treatment after component layers are formed. The change in the orientation of MgO reduces the MR ratio of the tunnel junction device.

In contrast, when a ferromagnetic layer adjacent to an insulating layer is amorphous as in CoFeB, the MgO (001) orientation is maintained in a heat treatment after component layers are formed. A tunnel junction device having a maintained MgO orientation has a high MR ratio.

The second pinned magnetic layer 22 (adjacent to the second pinned magnetic member) in the first pinned magnetic member and the first free magnetic layer 32 (adjacent to the first free magnetic member) in the second free magnetic member are amorphous. The first diffusion-blocking layer 24 (second pinned magnetic member) and the second diffusion-blocking layer 30 (first free magnetic member) probably become amorphous in accordance with the amorphous structures of the second pinned magnetic layer 22 and the first free magnetic layer 32 in a heat treatment after component layers are formed. The amorphous first diffusion-blocking layer 24 and the amorphous second diffusion-blocking layer 30 should have no significant adverse effect on the insulating layer 25. The first diffusion-blocking layer 24 and the second diffusion-blocking layer 30 each having an amorphous structure preferably have a small thickness; preferably 0.8 nm or less and more preferably 0.6 nm or less.

Thus, the first diffusion-blocking layer 24 and the second diffusion-blocking layer 30 have a thickness preferably in the range of 0.2 to 0.8 nm and more preferably in the range of 0.3 to 0.6 nm. Within these ranges, the tunnel junction device has a high breakdown voltage and a high MR ratio. The first diffusion-blocking layer and the second diffusion-blocking layer may have the same thickness or different thicknesses.

The first diffusion-blocking layer 24 (second pinned magnetic member) and the second diffusion-blocking layer 30 (first free magnetic member) are preferably formed of a boron-free material to improve the MR ratio and the breakdown voltage. However, in a ferromagnetic tunnel junction device according to the present embodiment, it is sufficient for the first diffusion-blocking layer 24 and the second diffusion-blocking layer 30 to contain less boron atoms than the second pinned magnetic layer 22 and the first free magnetic layer 32. This is because these diffusion-blocking layers can prevent boron atoms from diffusing from the second pinned magnetic layer 22 and the first free magnetic layer 32 into the insulating layer 25.

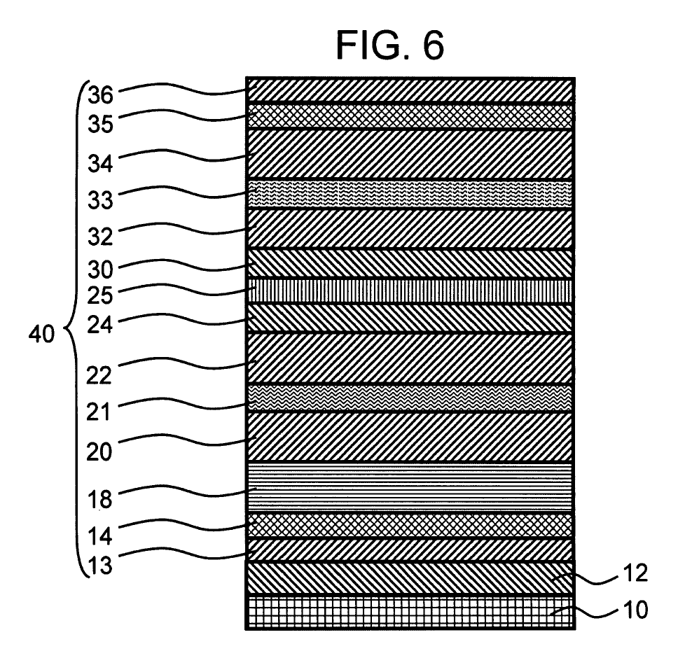

A method for manufacturing a ferromagnetic tunnel junction device according to the present embodiment will be described below with reference to FIG. 6. FIG. 6 is a cross-sectional view of a ferromagnetic tunnel junction according to an embodiment of the present invention. First, a supporting substrate 10 is prepared. The supporting substrate 10 may be a Si substrate, a Si substrate having a SiO₂ film thereon, a ceramic substrate, such as an AlTiC substrate, or a quartz glass substrate. If necessary, the supporting substrate 10 may have an electroconductive layer (not shown) thereon. The electroconductive layer may be formed of NiFe. The electroconductive layer may be planarized by chemical mechanical polishing (CMP). Second, the first underlying layer 13 to the second cap layer 36 are sequentially formed with a magnetron sputtering apparatus. The substrate is then heat-treated in a vacuum in a magnetic field. The heat treatment fixes the magnetization of the first pinned magnetic layer 20 and the second pinned magnetic layer 22, improves the MgO (001) orientation in the insulating layer 25, and recrystallizes the insulating layer side of the first free magnetic layer 32. The heat treatment may be performed at a temperature of 280° C., preferably in the range of 250° C. to 350° C., for four hours.

While the first underlying layer 13 to the second cap layer 36 are sequentially formed on the supporting substrate 10 in the method for manufacturing a ferromagnetic tunnel junction device described above, the second cap layer 36 to the first underlying layer 13 may be sequentially formed on the supporting substrate 10.

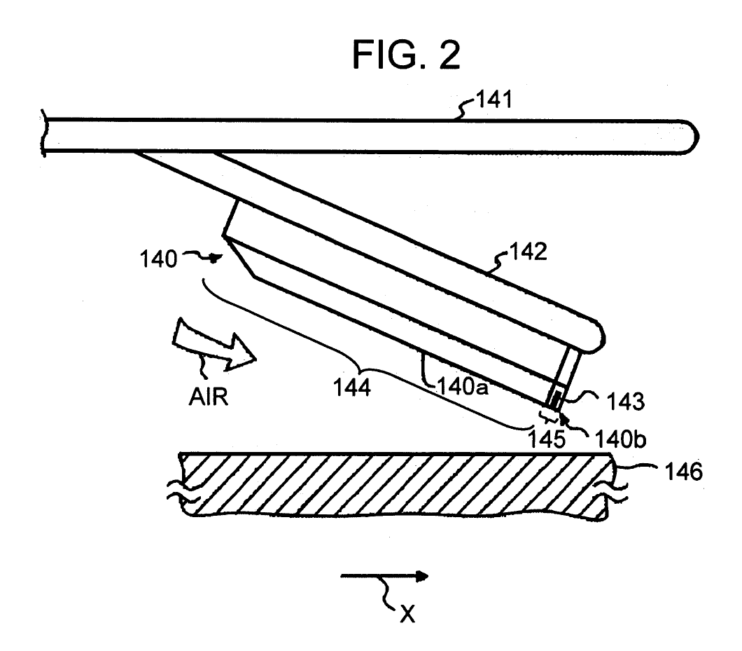

FIG. 2 is a cross-sectional view illustrating that a head slider provided with a magnetic head including the ferromagnetic tunnel junction device according to the first embodiment planes over a magnetic recording medium.

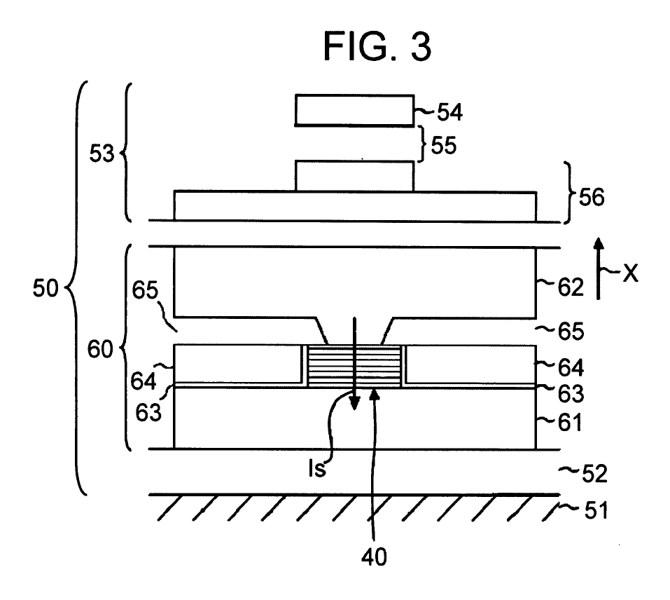

The head slider 140 includes a head slider substrate 51, for example, formed of Al₂O₃—TiC and a magnetic head 50 for writing information onto a magnetic recording medium 146 or reading information from the magnetic recording medium 146. The magnetic head 50 is disposed on a surface being opposite to the magnetic recording medium 146 (hereinafter referred to as “medium-opposing surface”) 140a on the side of an airflow outlet 140b. The magnetic head 50 is provided with an element unit 143, which includes a read element and an inductive recording element illustrated in FIG. 3.

The head slider 140 is fixed on a plate suspension 141 and a gimbal 142, which is connected to the tip of the suspension 141 with a spring member.

Airflow (in the direction of the arrow “AIR”) flowing over the magnetic recording medium 146, which moves in the direction of the arrow “X”, exerts a lifting power (upward force) on the medium-opposing surface 140a to lift the head slider 140. Simultaneously, the suspension 141 supporting the head slider 140 exerts a downward force. The equilibrium between the upward force and the downward force allows the head slider 140 to plane over the magnetic recording medium 146 at a predetermined flying height (distance between the surface of the element unit 143 and the surface of the magnetic recording medium 146). The element unit 143 detects a leakage magnetic field from a recording layer (not shown) of the magnetic recording medium 146.

FIG. 3 illustrates a principal part of the head slider 140 illustrated in FIG. 2. The magnetic head 50 includes a read element 60 formed on the head slider substrate 51, for example, formed of Al₂O₃—TiC. If necessary, the magnetic head 50 further includes an inductive recording element 53 disposed on the read element 60 and an alumina film or a hydrogenated carbon film.

The inductive recording element 53 includes a first magnetic pole 54 having a width corresponding to the track width of the magnetic recording medium 146 on the medium-opposing surface 140a, a recording gap layer 55 formed of a nonmagnetic material disposed under the first magnetic pole 54, a second magnetic pole 56 disposed under the recording gap layer 55, a yoke (not shown), which magnetically connects the first magnetic pole 54 to the second magnetic pole 56, and a coil (not shown) wound around the yoke, through which a write current induces a recording magnetic field. The first magnetic pole 54, the second magnetic pole 56, and the yoke are formed of a soft magnetic material having a high saturation magnetic flux density, such as a Ni8OFe20, CoZrNb, FeN, FeSiN, or FeCo alloy, to provide an adequate recording magnetic field. The inductive recording element 53 may be any known inductive recording element or a perpendicular magnetic recording element having a main magnetic pole and an auxiliary magnetic pole. The magnetic head 50 may include no inductive recording element.

The read element 60 includes, on an alumina insulating film 52 formed on a ceramic substrate 51, a first electrode 61, a ferromagnetic tunnel junction device 40, an alumina insulating film 65, and a second electrode 62. The second electrode 62 is electrically connected to the ferromagnetic tunnel junction device 40. Magnetic domain control layers 64 are disposed on both sides of the ferromagnetic tunnel junction device 40 with an insulating film 63 disposed therebetween. The magnetic domain control layers 64 may include a Cr film and a ferromagnetic CoCrPt film, layered in this order from the first electrode 61 side. The magnetic domain control layers 64 aim to achieve a single magnetic domain in the first pinned magnetic layer 20, the second pinned magnetic layer 22, the first free magnetic layer 32, and the second free magnetic layer 34 of the ferromagnetic tunnel junction device 40 illustrated in FIG. 1, thus preventing the generation of Barkhausen noise.

The first electrode 61 and the second electrode 62 function as a flow pass of a sensing current Is and as a magnetic shield, and are formed of a soft magnetic alloy, such as NiFe or CoFe. An electroconductive film, for example, a Cu film, a Ta film, or a Ti film may be provided between the first electrode 61 and the ferromagnetic tunnel junction device 40.

The ferromagnetic tunnel junction device 40 is a ferromagnetic tunnel junction device according to the first embodiment. Thus, the ferromagnetic tunnel junction device 40 will not be further described. The sensing current Is may flow from the second electrode 62 to the first electrode 61 almost perpendicularly through the ferromagnetic tunnel junction device 40. The tunneling resistance of the ferromagnetic tunnel junction device 40 varies with the strength and direction of the leakage magnetic field from the magnetic recording medium. The read element 60 may detect a change in the tunneling resistance of the ferromagnetic tunnel junction device 40 as a voltage change. Thus, the read element 60 reads information from the magnetic recording medium. The sensing current Is may flow in any direction, including the direction opposite to that illustrated in FIG. 3. The magnetic recording medium may also move in the opposite direction.

The read element 60 and the inductive recording element 53 may be covered with an alumina film or a diamond-like carbon (DLC) film to prevent corrosion.

Since the read element 60 in the magnetic head 50 includes the ferromagnetic tunnel junction device 40 having a high rate of tunneling resistance change, the magnetic head 50 has a high signal-to-noise ratio (S/N ratio). Even when the strength of leakage magnetic field from a magnetic recording medium is decreased owing to an increase in recording density, therefore, a signal detected by the magnetic head 50 has a high S/N ratio. Furthermore, the magnetic head 50 that includes the ferromagnetic tunnel junction device 40 having a high breakdown voltage has excellent durability.

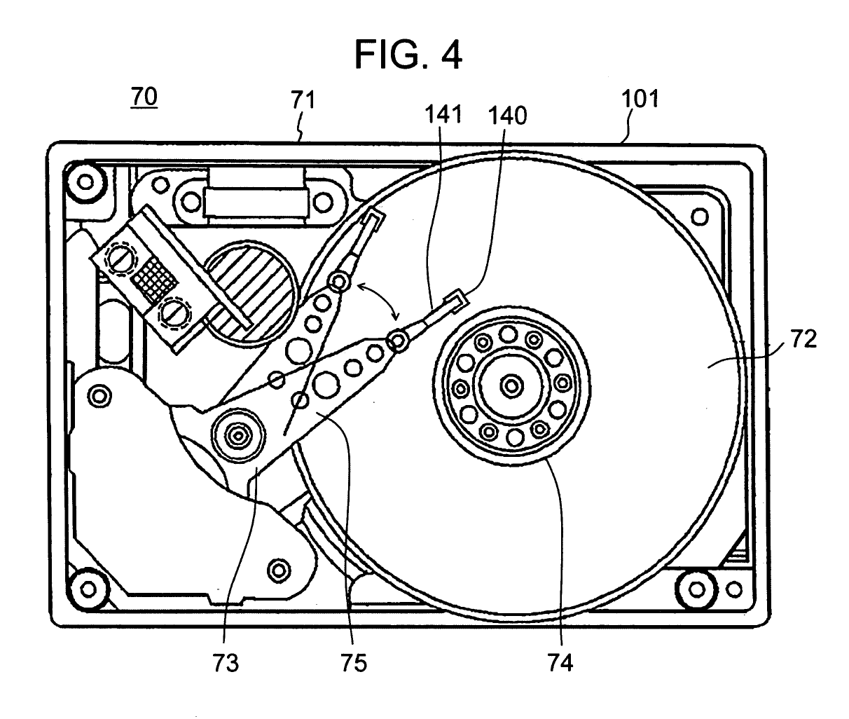

FIG. 4 is a schematic view of a principal part of a magnetic storage device provided with a magnetic head including the ferromagnetic tunnel junction device according to the first embodiment. A magnetic storage device 70 includes a housing 71, and a discoid magnetic recording medium 72, a head slider 140, and an actuator unit 73 in the housing 71. The magnetic recording medium 72 is supported by a hub 74 and is driven by a spindle motor (not shown). The head slider 140 includes the magnetic head 50 (not shown) described above. The head slider 140 is fixed to one end of a suspension 141. The other end of the suspension 141 is fixed to an arm 75, which is fixed to the actuator unit 73. The actuator unit 73 swings the head slider 140 in the radial direction of the magnetic recording medium 72. An electric circuit board (not shown) for read/write control, magnetic head position control, and spindle motor control is mounted on the other side of the housing 71.

The magnetic recording medium 72 may be a longitudinal magnetic recording medium, in which the easy direction of magnetization of a recording layer is parallel to the recording layer. The longitudinal magnetic recording medium may include an underlying layer formed of Cr or a Cr alloy, a recording layer formed of a CoCrPt alloy, a protective film, and a lubricating layer on a substrate in this order. The easy direction of magnetization of the recording layer becomes parallel to the recording layer under the influence of the underlying layer.

The magnetic recording medium 72 may also be a perpendicular magnetic recording medium, in which the easy direction of magnetization of a recording layer is perpendicular to the recording layer. The perpendicular magnetic recording medium may include a soft-magnetic backing layer, an intermediate layer, a recording layer of a perpendicularly magnetized film, a protective film, and a lubricating layer on a substrate in this order. The recording layer may have a ferromagnetic polycrystalline structure formed of a CoCrPt alloy or a CoCrPt—SiO₂ columnar granular structure. The easy direction of magnetization of the recording layer becomes substantially perpendicular to the recording layer under the influence of the intermediate layer or in a self-organizing manner. The magnetization retained in the perpendicular magnetic recording medium is more resistant to heat than the magnetization retained in the longitudinal magnetic recording medium. Thus, the perpendicular magnetic recording medium can achieve a recording density higher than that achieved by the longitudinal magnetic recording medium.

The magnetic recording medium 72 may be an obliquely-oriented magnetic recording medium, in which the easy direction of magnetization of a recording layer is inclined relative to the recording layer. The obliquely-oriented magnetic recording medium may include an underlying layer formed of Cr or a Cr alloy, a recording layer formed of a CoCrPt alloy, a protective film, and a lubricating layer on a substrate in this order. Crystal grains of the underlying layer are obliquely stacked. Thus, the underlying layer has an oblique crystalline orientation. Under the influence of the underlying layer, the easy axis of magnetization of the recording layer is inclined relative to the recording layer. The magnetization direction of such a recording layer can be reversed by a weak recording magnetic field generated by a magnetic head. The recording layer therefore has excellent writing performance. Thus, the obliquely-oriented magnetic recording medium can achieve a higher recording density than the longitudinal magnetic recording medium or the perpendicular magnetic recording medium.

The head slider 140 includes the magnetic head 145 (not shown) described above. The read element 60 in the magnetic head 50 has a high S/N ratio. Even when the strength of leakage magnetic field from the magnetic recording medium 72 is decreased owing to an increase in recording density, therefore, a signal detected by the magnetic head 50 has a high S/N ratio. Thus, the magnetic storage device 70 is ready for a higher recording density.

Basic configuration of the magnetic storage device 70 is not limited to that illustrated in FIG. 4. The shape of the magnetic recording medium 72 is not limited to discoid. For example, the magnetic storage device 70 may be a helical scan-type or a lateral-type magnetic tape unit. For the helical scan-type magnetic tape unit, the magnetic head 50 is installed in a cylinder head. For the lateral-type magnetic tape unit, the magnetic head 50 is installed in a head block, which a magnetic tape is in contact with while the magnetic tape runs in the longitudinal direction.

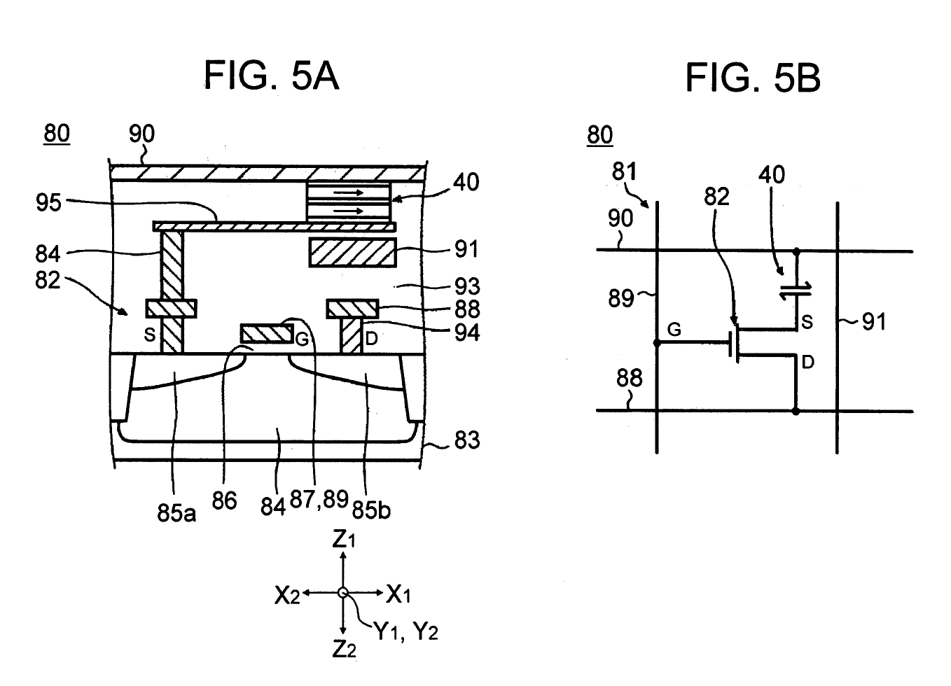

FIG. 5A is a cross-sectional view of a magnetic random access memory (MRAM) including the ferromagnetic tunnel junction device according to the first embodiment. FIG. 5B is an equivalent circuit diagram of the magnetic random access memory. FIG. 5A also illustrates rectangular coordinate axes. The Y1 and Y2 directions are perpendicular to the drawing; the Y1 direction is toward the back of the drawing, and the Y2 direction is toward the front of the drawing. The X direction refers to the X1 direction or the X2 direction. The same applies to the Y direction and the Z direction.

A magnetic memory device 80 includes a plurality of memory cells 81, which includes a ferromagnetic tunnel junction device 40 and a MOS field-effect transistor (FET) 82. The MOSFET may be a p-channel MOSFET or an n-channel MOSFET. The present embodiment describes a magnetic memory device 80 including an n-channel MOSFET, in which electrons serve as carriers.

The MOSFET 82 includes a p-well region 84 formed in the silicon substrate 83, and first and second impurity diffusion regions 85a and 85b formed near the top face of the silicon substrate 83 in the p-well region 84. The p-well region 84 is doped with a p-type impurity, and the first and second impurity diffusion regions 85a and 85b are doped with an n-type impurity. The first impurity diffusion region 85a serves as a source S, and the second impurity diffusion region 85b serves as a drain D. A gate electrode 87 is disposed on a gate insulating film 86 formed on the silicon substrate 83 between the first and second impurity diffusion regions 85a and 85b.

The source S of the MOSFET 82 is electrically connected to one end of the ferromagnetic tunnel junction device 40, for example, the first underlying layer 13 of the ferromagnetic tunnel junction device 40 illustrated in FIG. 1. The drain D is electrically connected to a plate line 88. The gate electrode 87 is electrically connected to a read word line 89. The gate electrode 87 may also serve as the read word line 89.

While the ferromagnetic tunnel junction device 40 is not illustrated in detail, it has the same configuration as the ferromagnetic tunnel junction device 40 illustrated in FIG. 1. The first free magnetic layer 32 and the second free magnetic layer 34 have the easy axis of magnetization in the X direction and the hard axis of magnetization in the Y direction. The direction of the easy axis of magnetization may be adjusted by heat treatment or shape anisotropy. When the easy axis of magnetization is formed in the X direction by shape anisotropy, the shape of a cross section parallel to the top face of the ferromagnetic tunnel junction device 40 (the shape of a cross section parallel to the X-Y plane) is rectangular with the long sides being in the X direction.

The other end of the ferromagnetic tunnel junction device 40, for example, the second cap layer 36, is electrically connected to a bit line 90. As described above, one end of the ferromagnetic tunnel junction device 40 is electrically connected to the source S of the MOSFET 82. A writing word line 91 is disposed below the ferromagnetic tunnel junction device 40.

The silicon substrate 83 and the gate electrode 87 are covered with an interlayer insulating film 93, such as a silicon nitride film or a silicon oxide film. Except for the electrical connections, the ferromagnetic tunnel junction device 40, the plate line 88, the read word line 89, the bit line 90, the writing word line 91, a vertical line 94, and an interlayer line 95 are electrically insulated from one another by the interlayer insulating film 93.

Read/write operations of the magnetic memory device 80 will be described below. Information is written onto the ferromagnetic tunnel junction device 40 by the bit line 90 and the writing word line 91 disposed above and below the ferromagnetic tunnel junction device 40. The bit line 90 extends in the X direction above the ferromagnetic tunnel junction device 40. A magnetic field can be applied to the ferromagnetic tunnel junction device 40 in the Y direction by sending an electric current through the bit line 90. The writing word line 91 extends in the Y direction below the ferromagnetic tunnel junction device 40. A magnetic field can be applied to the ferromagnetic tunnel junction device 40 in the X direction by sending an electric current through the writing word line 91.

The magnetization of the first free magnetic layer and the second free magnetic layer in the ferromagnetic tunnel junction device 40 consistently points the X direction (for example, the X2 direction) substantially in the absence of magnetic field. The magnetization directions of the first free magnetic layer and the second free magnetic layer are identical owing to the ferromagnetic exchange coupling. For convenience of explanation, “magnetization of the first free magnetic layer and the second free magnetic layer” is hereinafter referred to simply as “magnetization of free magnetic laminate”, unless otherwise specified.

An electric current can be sent simultaneously through the bit line 90 and the writing word line 91 to write information on the ferromagnetic tunnel junction device 40. For example, an electric current is sent through the writing word line 91 in the Y1 direction to alter the magnetization of the free magnetic laminate in the X1 direction. As a result, the direction of the magnetic field in the ferromagnetic tunnel junction device 40 turns to the X1 direction. The direction of the electric current passing through the bit line 90 may be the X1 direction or the X2 direction. The direction of the magnetic field in the ferromagnetic tunnel junction device 40 generated by an electric current passing through the bit line 90 turns to the Y1 direction or the Y2 direction. Thus, the magnetization of the free magnetic laminate functions as part of a magnetic field for crossing the barrier of the hard axis of magnetization. More specifically, the magnetic field in the X1 direction and the magnetic field in the Y1 direction or the Y2 direction are simultaneously applied to the magnetization of the free magnetic laminate to turn the magnetization direction of the free magnetic laminate from the X2 direction to the X1 direction. Even after the magnetic field is eliminated, the magnetization of the free magnetic laminate points the X1 direction, and remains stable until the next writing magnetic field or an erasing magnetic field is applied. The strength of the magnetic field applied to reverse the magnetization direction of the free magnetic laminate is described as follows.

Thus, depending on the magnetization direction of the free magnetic laminate, “1” or “0” can be written onto the ferromagnetic tunnel junction device 40. For example, when the magnetization direction of the pinned magnetic layer points the X1 direction, the magnetization direction of the free magnetic laminate is set to the X1 direction (low tunneling resistance) for “1” and to the X2 direction (high tunneling resistance) for “0”.

The writing current passing through the bit line 90 or the writing word line 91 alone cannot reverse the magnetization direction of the free magnetic laminate. Thus, information is written onto the ferromagnetic tunnel junction device 40 only at an intersection point of the bit line 90 and the writing word line 91.

When an electric current is sent through the bit line 90 in the write operation, the source S is set to have a high impedance to prevent the electric current from flowing through the ferromagnetic tunnel junction device 40.

The read operation of the ferromagnetic tunnel junction 40 is performed by applying a negative voltage to the bit line 90 relative to the source S and applying a voltage (positive voltage) higher than the threshold voltage of the MOSFET 82 to the read word line 89 or the gate electrode 87. This turns on the MOSFET, sending electrons from the bit line 90 to the plate line 88 via the ferromagnetic tunnel junction device 40, the source S, and the drain D. The tunneling resistance of the ferromagnetic tunnel effect depending on the magnetization direction of the free magnetic laminate is determined by the number of electrons per unit time, that is, the electric current. Thus, “1” or “0” information retained by the ferromagnetic tunnel junction device 40 can be read.

As described in the first embodiment, the ferromagnetic tunnel junction device 40 has a high rate of tunneling resistance change. The large difference between tunneling resistances corresponding to “0” and “1” allows the magnetic memory device 80 to read the information accurately. The ferromagnetic tunnel junction device 40 also has a high breakdown voltage. The magnetic memory device including the ferromagnetic tunnel junction device 40 is therefore highly reliable.

While the bit line 90 and the source S are electrically connected to the second cap layer 36 and the first underlying layer 13 of the ferromagnetic tunnel junction device 40, respectively, the connections may be reversed. The configuration of the magnetic memory device 80 is not limited to that described above. The ferromagnetic tunnel junction device illustrated in FIG. 1 may also be applied to a known magnetic memory device.

The present invention is not limited to the embodiments described above. The embodiments described above are provided only for illustrative purposes. Other embodiments that are based on substantially the same technical idea as that described in the claims of the present invention and that have substantially the same operational advantages as those of the present invention are within the technical scope of the present invention.

In a ferromagnetic tunnel junction device according to the embodiments described above, the boron contents in the first pinned magnetic member and the second free magnetic member are lower than those in the second pinned magnetic member and the first free magnetic member, respectively. Boron atoms in the first pinned magnetic member and the second free magnetic member therefore negligibly diffuse into the insulating layer. Thus, a ferromagnetic tunnel junction device according to the embodiments described above has a high rate of magnetoresistance change and a high breakdown voltage.

### EXAMPLES

### Example 1

A tunnel junction device according to Example 1 was produced using the following procedure to determine the MR ratio described later. An electroconductive layer 12 formed of Ta (3 nm)/Cu (30 nm) was formed on a Si substrate 10 with a magnetron sputtering apparatus to determine the MR ratio by a current-in-plane tunneling (CIPT) method described later. As illustrated in FIG. 6, a first underlying layer 13 formed of Ta (3 nm), a second underlying layer 14 formed of Ru (2 nm), a pinning layer 18 formed of Ir21Mn79 (7 nm), a first pinned magnetic layer 20 formed of Co65Fe35 (2 nm), a nonmagnetic coupling layer 21 formed of Ru (0.8 nm), a second pinned magnetic layer 22 formed of Co40Fe40B20 (2 nm), a first diffusion-blocking layer 24 formed of Co50Fe50 (0.5 nm), an insulating layer 25 formed of MgO (1.0 nm), a second diffusion-blocking layer 30 formed of Co50Fe50 (0.6 nm), a first free magnetic layer 32 formed of Co70Fe10B20 (2 nm), a third diffusion-blocking layer 33 formed of Ta (0.25 nm), a second free magnetic layer 34 formed of Ni90Fe10 (3 nm), a first cap layer 35 formed of Ta (5 nm), an electroconductive layer (not shown) formed of Cu (5 nm), which was necessary to determine the MR ratio by the CIPT method described later, and a second cap layer 36 formed of Ru (10 nm) were sequentially formed on the electroconductive layer 12 with the magnetron sputtering apparatus. Thus, a tunnel junction device having a multilayer structure was produced. The numeral in parentheses indicates a film thickness. The same applies to Examples and Comparative Examples. The tunnel junction was then heat-treated at 270° C. in a magnetic field in a vacuum for four hours.

### Example 2

A ferromagnetic tunnel junction device according to Example 2 was produced in the same manner as Example 1, except that Co50Fe50 (0.6 nm) was replaced by Co50Fe50 (0.4 nm) in the second diffusion-blocking layer 30.

### Example 3

A ferromagnetic tunnel junction device according to Example 3 was produced in the same manner as Example 1, except that Co50Fe50 (0.6 nm) was replaced by Co50Fe50 (0.2 nm) in the second diffusion-blocking layer 30.

### Example 4

A ferromagnetic tunnel junction device according to Example 4 was produced in the same manner as Example 1, except that Co50Fe50 (0.6 nm) was replaced by Co50Fe50 (0.3 nm) in the second diffusion-blocking layer 30.

### Example 5

A ferromagnetic tunnel junction device according to Example 5 was produced in the same manner as Example 1, except that Co50Fe50 (0.6 nm) was replaced by Co65Fe35 (0.8 nm) in the second diffusion-blocking layer 30 and that Co70Fe10B20 (1.5 nm) was replaced by Co70Fe10B20 (1.0 nm) in the first free magnetic layer 32.

### Example 6

A ferromagnetic tunnel junction device according to Example 6 was produced in the same manner as Example 5, except that Co65Fe35 (0.8 nm) was replaced by Co65Fe35 (0.7 nm) in the second diffusion-blocking layer 30.

### Example 7

A ferromagnetic tunnel junction device according to Example 7 was produced in the same manner as Example 5, except that Co65Fe35 (0.8 nm) was replaced by Co65Fe35 (0.5 nm) in the second diffusion-blocking layer 30.

### Example 8

A ferromagnetic tunnel junction device according to Example 8 was produced in the same manner as Example 5, except that Co65Fe35 (0.8 nm) was replaced by Co65Fe35 (0.3 nm) in the second diffusion-blocking layer 30.

### Example 9

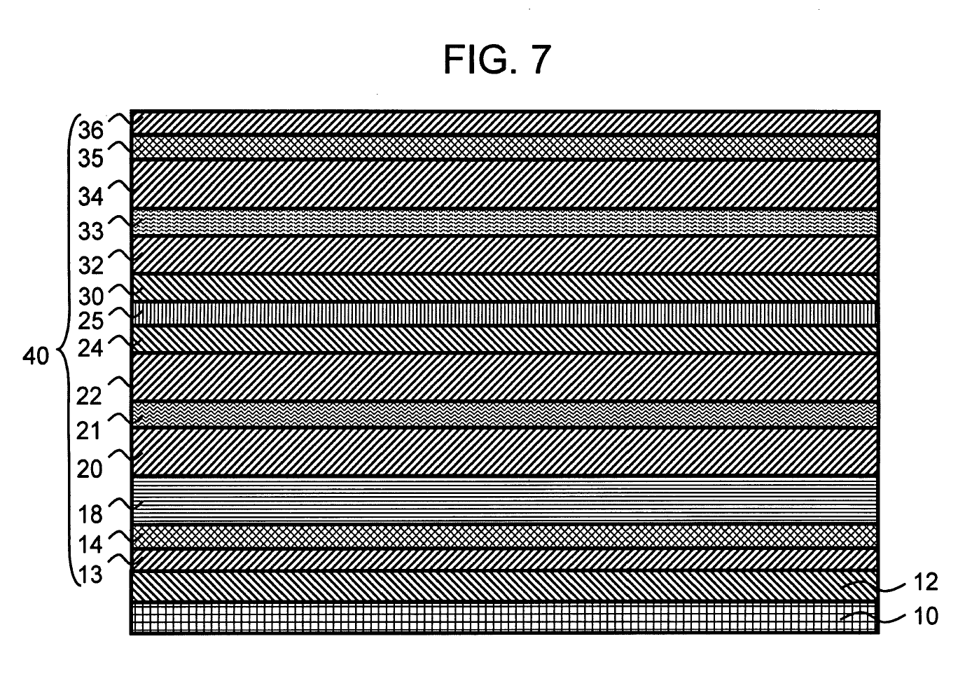

A ferromagnetic tunnel junction device according to Example 9 was produced using the following procedure to determine the breakdown voltage described later. First, an electroconductive layer 12 formed of NiFe (1 μm) was formed on a Si substrate 10 by plating and was subjected to chemical mechanical polishing (CMP). As illustrated in FIG. 7, a first underlying layer 13 formed of Ta (3 nm), a second underlying layer 14 formed of Ru (2 nm), a pinning layer 18 formed of Ir21Mn79 (7 nm), a first pinned magnetic layer 20 formed of Co65Fe35 (2 nm), a nonmagnetic coupling layer 21 formed of Ru (0.8 nm), a second pinned magnetic layer 22 formed of Co40Fe40B20 (2 nm), a first diffusion-blocking layer 24 formed of Co50Fe50 (0.5 nm), an insulating layer 25 formed of MgO (1.0 nm), a second diffusion-blocking layer 30 formed of Co50Fe50 (0.6 nm), a first free magnetic layer 32 formed of Co70Fe10B20 (2 nm), a third diffusion-blocking layer 33 formed of Ta (0.25 nm), a second free magnetic layer 34 formed of Ni90Fe10 (3 nm), a first cap layer 35 formed of Ta (5 nm), and a second cap layer 36 formed of Ru (10 nm) were sequentially formed on the electroconductive layer 12 with the magnetron sputtering apparatus. The numeral in parentheses indicates a film thickness. The same applies to Examples and Comparative Examples. The resulting multilayer structure was then heat-treated at 270° C. in a magnetic field in a vacuum for four hours.

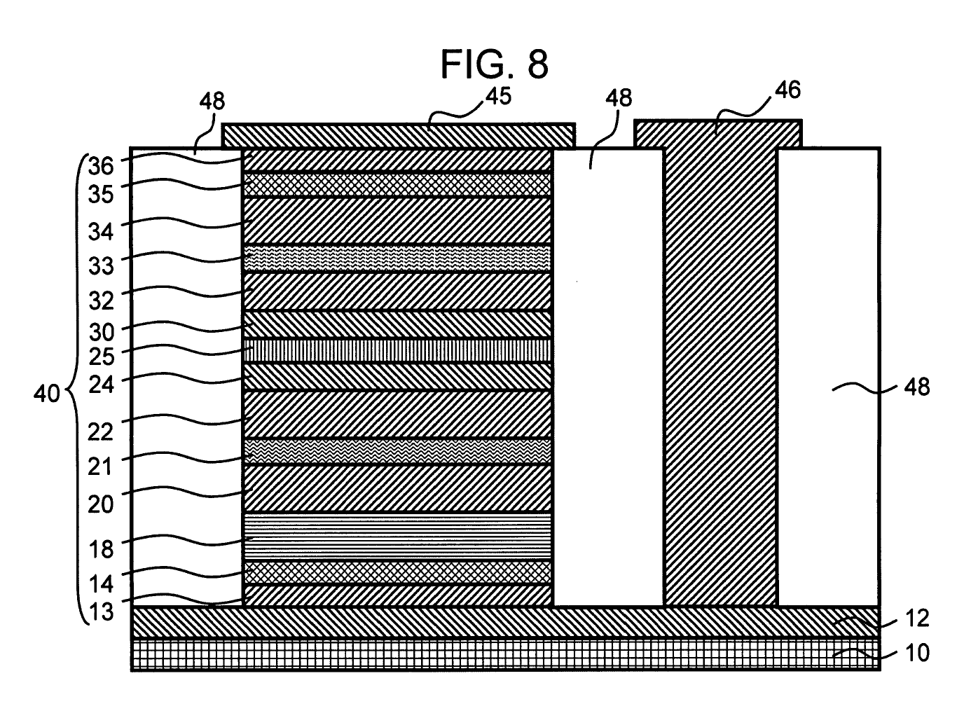

An insulating film 48 formed of alumina (Al₂O₃) was then formed with a RF sputtering apparatus. Part of the insulating film 48 was removed by a lift-off process to form a via hole reaching the electroconductive layer 12. As illustrated in FIG. 8, a first copper electrode 45 and a second copper electrode 46 were formed by sputtering on the second cap layer 36 and a portion from which the insulating film 48 was removed, respectively.

As illustrated in FIG. 6, a tunnel junction device for use in the measurement of the MR ratio was produced in the same manner as described above, except that NiFe (1 μm) in the electroconductive layer 12 was replaced by Ta (3 nm)/Cu (30 nm) formed with the magnetron sputtering apparatus and that an electroconductive layer (not shown) formed of Cu (5 nm), which was necessary to determine the MR ratio by the CIPT method described later, was formed with the magnetron sputtering apparatus between the first cap layer 35 and the second cap layer 36.

### Example 10

A ferromagnetic tunnel junction device according to Example 10 was produced in the same manner as Example 9, except that Co50Fe50 (0.6 nm) was replaced by Co50Fe50 (0.3 nm) in the second diffusion-blocking layer 30. A tunnel junction device for use in the measurement of the MR ratio was also produced.

### Example 11

A ferromagnetic tunnel junction device according to Example 11 was produced in the same manner as Example 9, except that Co50Fe50 (0.6 nm) was replaced by Co65Fe35 (0.3 nm) in the second diffusion-blocking layer 30.

### Comparative Example 1

A ferromagnetic tunnel junction device according to Comparative Example 1 was produced in the same manner as Example 1, except that the first diffusion-blocking layer 24 and the second diffusion-blocking layer 30 were not formed.

### Comparative Example 2

A ferromagnetic tunnel junction device according to Comparative Example 2 was produced in the same manner as Example 9, except that the first diffusion-blocking layer 24 and the second diffusion-blocking layer 30 were not formed.

Evaluation

Rate of Magnetoresistance Change (MR Ratio)

The rate of magnetoresistance change and the tunnel resistivity (product of the resistance in the thickness direction and the area of a tunnel junction device) of the ferromagnetic tunnel junction devices according to Examples 1 to 3 and Comparative Example 1 were determined by the CIPT method. The CIPT method is described in detail in Applied Physics Letter, vol. 83, No. 1, pp. 84-86 (2003). The rate of magnetoresistance change was a mean value of six measurements with a scanning probe microscope (Capres, “SPM-CIPTech”).

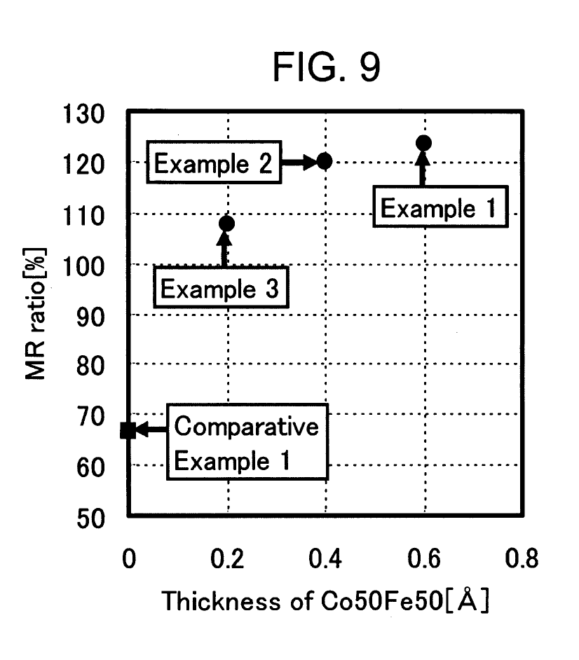

FIG. 9 is a graph illustrating the MR ratio as a function of the thickness of a second diffusion-blocking layer in the ferromagnetic tunnel junction devices according to Examples 1 to 3 and Comparative Example 1. The ferromagnetic tunnel junction devices each including the first diffusion-blocking layer and the second diffusion-blocking layer according to Examples 1 to 3 had a higher MR ratio than the ferromagnetic tunnel junction device according to Comparative Example 1. The tunneling resistance RA of the samples ranged from 2.1 to 2.2 (Ωμm²).

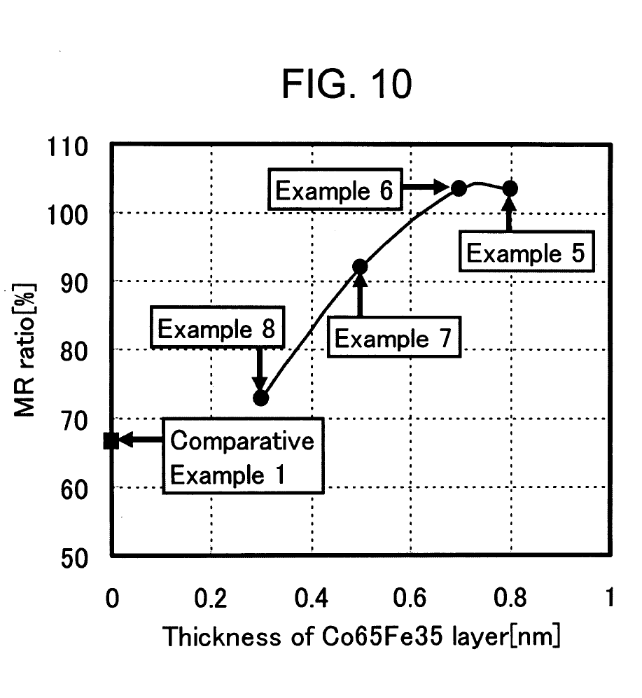

FIG. 10 is a graph illustrating the MR ratio as a function of the thickness of a second diffusion-blocking layer in the ferromagnetic tunnel junction devices according to Examples 5 to 8 and Comparative Example 1. The ferromagnetic tunnel junction devices including the first diffusion-blocking layer and the second diffusion-blocking layer according to Examples 5 to 8 had a higher MR ratio than the ferromagnetic tunnel junction device according to Comparative Example 1. The tunneling resistance RA of the samples ranged from 2.1 to 2.3 (Ωμm²).

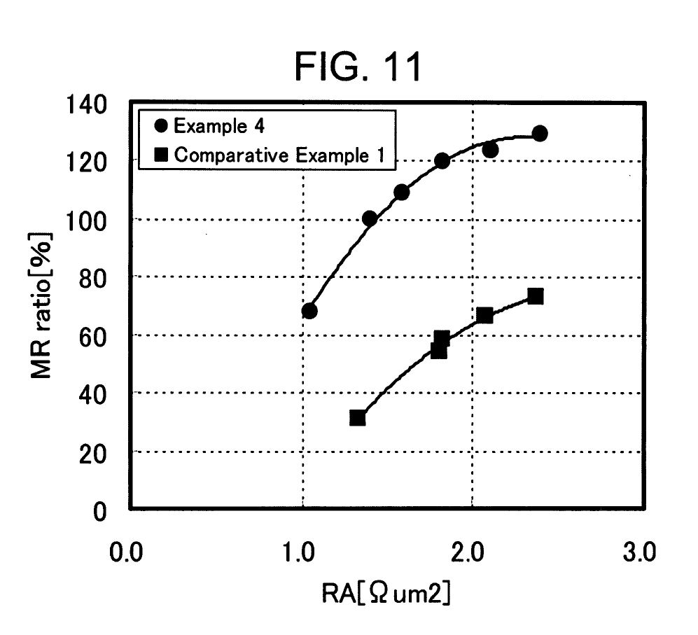

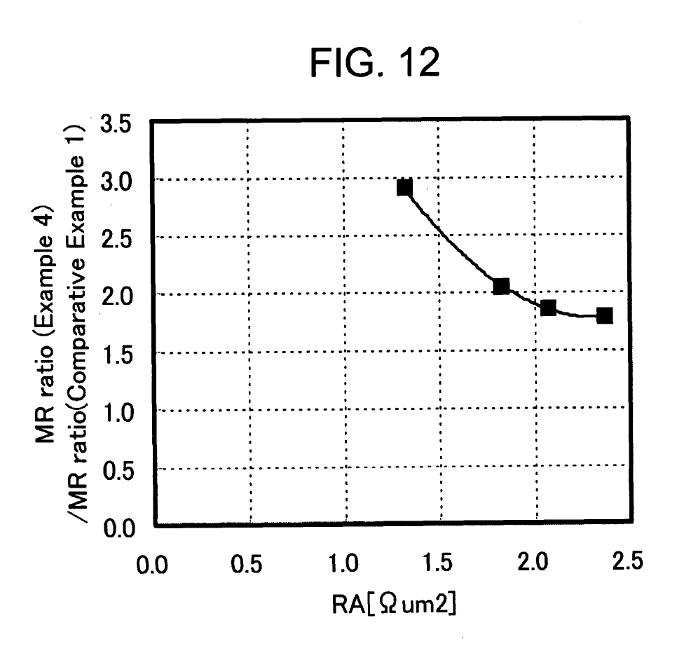

FIG. 11 is a graph illustrating the MR ratio as a function of the tunneling resistance RA in the ferromagnetic tunnel junction devices according to Example 4 and Comparative Example 1. The ferromagnetic tunnel junction device according to Example 4 had higher MR ratios than the ferromagnetic tunnel junction device according to Comparative Example 1 at any tunneling resistance RA. FIG. 12 is a graph illustrating the ratio of the MR ratio of the ferromagnetic tunnel junction device according to Example 4 to the MR ratio of the ferromagnetic tunnel junction device according to Comparative Example 1 as a function of the tunneling resistance RA. The MR ratio was improved particularly at a low RA range.

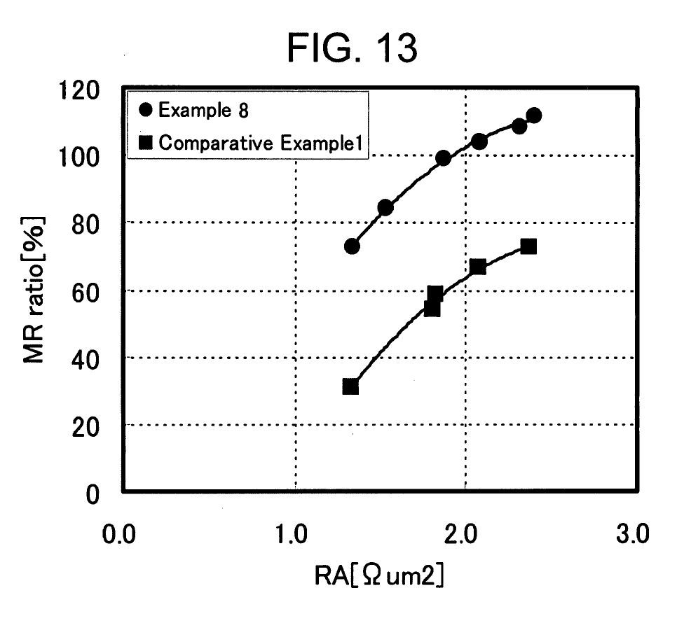

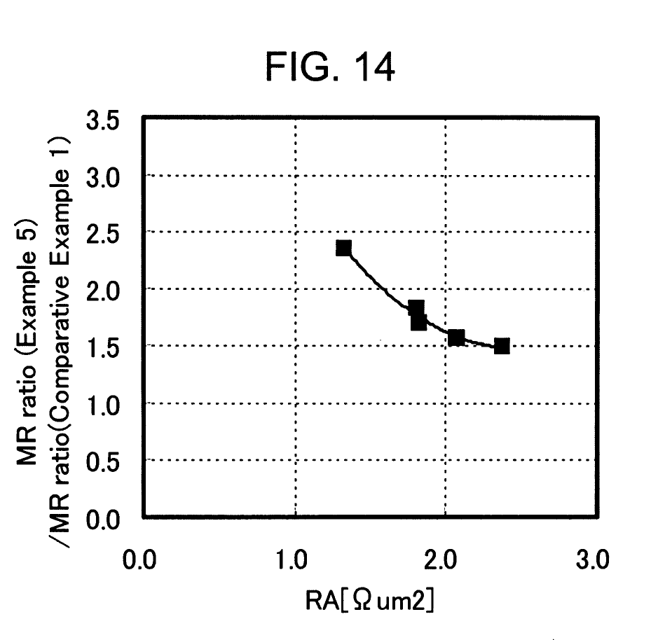

FIG. 13 is a graph illustrating the MR ratio as a function of the tunneling resistance RA in the ferromagnetic tunnel junction devices according to Example 8 and Comparative Example 1. The ferromagnetic tunnel junction device according to Example 8 had higher MR ratios than the ferromagnetic tunnel junction device according to Comparative Example 1 at any tunneling resistance RA. FIG. 14 is a graph illustrating the ratio of the MR ratio of the ferromagnetic tunnel junction device according to Example 8 to the MR ratio of the ferromagnetic tunnel junction according to Comparative Example 1 as a function of the tunneling resistance RA. The MR ratio was improved particularly at a low RA range.

Breakdown Voltage

The breakdown voltage (BDV) of the ferromagnetic tunnel junction devices according to Examples 9, 10, and 11 and Comparative Example 2 each having a tunneling resistance RA of 2.2 Ωμm² was determined by the CIPT method.

A pulse voltage was applied to the first electrode 45 and the second electrode 46 until the dielectric breakdown was observed, that is, until the electrical resistance became zero. The initially applied voltage was 350 mV, and the pulse width was 200 ms. The pulse voltage was increased by 10 mV at each pulse. The voltage at which the electrical resistance became zero is the breakdown voltage.

TABLE 1

| | BDV (mV) |
|---|---|
| Example 9 | 620 |
| Example 10 | 596 |
| Example 11 | 603 |
| Comparative Example 2 | 530 |

Table 1 shows the measurements of breakdown voltage. The ferromagnetic tunnel junction devices according to Examples 9, 10, and 11, which included the first diffusion-blocking layer and the second diffusion-blocking layer, had a higher breakdown voltage than the ferromagnetic tunnel junction device according to Comparative Example 2, which included neither the first diffusion-blocking layer nor the second diffusion-blocking layer.

What is claimed is:

1. A ferromagnetic tunnel junction device comprising:
a first fixed magnetic member including a ferromagnetic material having a boron atom, the magnetization direction of the first fixed magnetic member being capable of being fixed;
a second fixed magnetic member including a ferromagnetic material on the first fixed magnetic member, the magnetization direction of the second fixed magnetic member being capable of being fixed, the content of the boron atom in the second fixed member being smaller than that in the first fixed member;
a first free magnetic member superposed with respect to the second fixed layer, including a ferromagnetic material, the magnetization direction of the first free magnetic member being variable;
an insulating layer between the second fixed magnetic layer and the first free magnetic layer, the insulating layer being capable of conducting tunneling current therethrough; and
a second free magnetic member including a ferromagnetic material having a boron atom on the first free magnetic member, the magnetization direction of the second free magnetic member being variable, the content of the boron atom in the second free member being smaller than that in the first free member.

2. The ferromagnetic tunnel junction device according to claim 1, wherein the second fixed magnetic member includes at least one element selected from the group consisting of Co, Fe, and Ni.

3. The ferromagnetic tunnel junction device according to claim 1, wherein the first free magnetic member includes at least one element selected from the group consisting of Co, Fe, and Ni.

4. The ferromagnetic tunnel junction device according to claim 1, wherein the insulating layer includes at least one element selected from the group consisting of Mg, Ti, Ta, and Al.

5. The ferromagnetic tunnel junction device according to claim 1, wherein the second fixed layer and the first free magnetic layer have a thickness in the range of 0.2 to 0.6 nm.

6. The ferromagnetic tunnel junction device according to claim 1, wherein a content ratio of the boron atom in the insulating layer is lower than those in the second fixed magnetic member and the first free magnetic member.

7. A magnetic head comprising:
a ferromagnetic tunnel junction device including:
a first fixed magnetic member including a ferromagnetic material having a boron atom, the magnetization direction of the first fixed magnetic member being capable of being fixed;
a second fixed magnetic member including a ferromagnetic material on the first fixed magnetic member, the magnetization direction of the second fixed magnetic member being capable of being fixed, the content of the boron atom in the second fixed member being smaller than that in the first fixed member;
a first free magnetic member superposed with respect to the second fixed layer, including a ferromagnetic material, the magnetization direction of the first free magnetic member being variable;
an insulating layer between the second fixed magnetic layer and the first free magnetic layer, the insulating layer being capable of conducting tunneling current therethrough; and
a second free magnetic member including a ferromagnetic material having a boron atom on the first free magnetic member, the magnetization direction of the second free magnetic member being variable, the content of the boron atom in the second free member being smaller than that in the first free member.

8. A magnetic storage device comprising:
a ferromagnetic tunnel junction device including:
a first fixed magnetic member including a ferromagnetic material having a boron atom, the magnetization direction of the first fixed magnetic member being capable of being fixed;
a second fixed magnetic member including a ferromagnetic material on the first fixed magnetic member, the magnetization direction of the second fixed magnetic member being capable of being fixed, the content of the boron atom in the second fixed member being smaller than that in the first fixed member;
a first free magnetic member superposed with respect to the second fixed layer, including a ferromagnetic material, the magnetization direction of the first free magnetic member being variable;
an insulating layer between the second fixed magnetic layer and the first free magnetic layer, the insulating layer being capable of conducting tunneling current therethrough; and
a second free magnetic member including a ferromagnetic material having a boron atom on the first free magnetic member, the magnetization direction of the second free magnetic member being variable, the content of the boron atom in the second free member being smaller than that in the first free member.

9. The magnetic storage device according to claim 8 further comprising:
means for applying magnetic field to the ferromagnetic tunnel junction device so that each magnetization direction of the first free magnetic member and the second free magnetic member turn in a predetermined direction; and
means for supplying sense current to the ferromagnetic tunnel junction device so as to sense a tunnel resistance thereof.

10. The magnetic storage device according to claim 8 further comprising:
a magnetic storage medium for writing information to and reading information from the magnetic storage medium; and
a magnetic head facing the magnetic storage medium for reading information from the magnetic storage medium, the magnetic head including the ferromagnetic tunnel junction device.

11. The ferromagnetic tunnel junction device according to claim 1, wherein the second fixed magnetic member consists essentially of CoFe.

12. The ferromagnetic tunnel junction device according to claim 1, wherein the first free fixed magnetic member consists essentially of CoFe.

13. The ferromagnetic tunnel junction device according to claim 1, wherein the second free magnetic member includes:
a first free magnetic layer consisting essentially of CoFeB; and
a second free magnetic layer consisting essentially of NiFe on the first free layer.

14. The ferromagnetic tunnel junction device according to claim 13, wherein the second free magnetic member further includes a metal layer for constrain a diffusion of the boron atom from the first free magnetic layer to the second free magnetic layer, the metal layer being between the first free magnetic layer and the second free magnetic layer.

15. The ferromagnetic tunnel junction device according to claim 1, wherein the first fixed magnetic member includes a layer adjacent to the second fixed magnetic member, the layer having the ferromagnetic material and the boron.

16. The ferromagnetic tunnel junction device according to claim 1, wherein the second free magnetic member includes a layer adjacent to the first free magnetic member, the layer having the ferromagnetic material and the boron.
